(19) United States
(12) Patent Application Publication
(10) Pub. No.: US 2025/0326664 A1
(43) Pub. Date: Oct. 23, 2025

(54) REGENERATION CYCLE FOR A WATER SOFTENER

(71) Applicant: Haier US Appliance Solutions, Inc., Wilmington, DE (US)

(72) Inventors: Gregory Sergeevich Chernov, Louisville, KY (US); Keaton Spitler, Louisville, KY (US)

(21) Appl. No.: 18/639,398

(22) Filed: Apr. 18, 2024

(51) Int. Cl. C02F 1/42; B01J 49/75; B01J 49/85

(52) U.S. Cl. CPC C02F 1/42; B01J 49/75; B01J 49/85; C02F 2001/425; C02F 2201/005; C02F 2209/003; C02F 2209/05; C02F 2209/40; C02F 2303/16

(57) ABSTRACT

A water softener includes a water tank for holding resin beads, the water tank comprising a water inlet for receiving untreated water and a water outlet for discharging treated water, a salt reservoir for generating brine that is used to regenerate the resin beads, a conductivity sensing assembly operably coupled to the water tank, and a controller in operative communication with the conductivity sensing assembly. The controller is configured to obtain an untreated electrical conductivity of the untreated water, obtain a treated electrical conductivity of the treated water, determine that a regeneration cycle is needed based at least in part on the untreated electrical conductivity and the treated electrical conductivity, and perform the regeneration cycle in response to determining that the regeneration cycle is needed.

### FIELD OF THE INVENTION

The present subject matter relates generally to water softeners, and more particularly to methods for performing regeneration cycles in a water softener.

### BACKGROUND OF THE INVENTION

Residential and commercial appliances commonly use tap water to facilitate the performance of operating cycles. This tap water is often supplied from an external source, e.g., such as a water distribution system connected to a well or a public water main serviced by a water company. Tap water may include various impurities, such as minerals, e.g., calcium, iron, or magnesium, which may contribute to water “hardness.” Tap water containing high concentrations of such minerals, e.g., hard tap water, may negatively affect the appearance and/or taste of ice cubes formed from the tap water or may negatively affect the operation of various appliances, e.g., due to mineral deposits, scale, or other accumulations in or on components of the appliance.

Accordingly, water softeners may frequently be used to reduce or remove such minerals prior to supplying the water to the appliance. For example, particularly in areas with hard water, residences may include a water softener installed on the main water supply connected to the public water main. These water softeners may prevent common water problems associated with hard water, including mineral deposits, scale buildup, leaky faucets, clogged pipes, damage to water-based appliances, chalky films on dishwasher cleaned glasses, dry skin and hair after showering, and faded colored clothing from the washing machine.

Certain conventional water softeners rely on the principle of ion exchange to remove undesirable minerals from water. In this regard, ion exchange is a chemical process that substitutes sodium for the minerals that make water hard. For example, water may pass through a tank with resin beads saturated with sodium, and these beads may exchange calcium and magnesium ions in the water with sodium ions. Notably, over time, the resin beads become saturated with the minerals that have been extracted from the hard water, and the water softener must go through a “regeneration” cycle, during which sodium-rich water restores the resin beads to their initial sodium-saturated state. Upon completion of the cycle, the softener returns to regular operation, softening the household water that passes through it. However, conventional water softener appliances rely on simple time-based or volume-based initiation of resin regeneration, resulting in regeneration cycles that may be performed too early (resulting in inefficiencies) or too late (resulting in the discharge of hard water).

Accordingly, an improved water softener is desired. More specifically, a water softener with features for performing regeneration cycles at more desirable and intelligent times would be particularly beneficial.

### BRIEF DESCRIPTION OF THE INVENTION

Aspects and advantages of the invention will be set forth in part in the following description, or may be apparent from the description, or may be learned through practice of the invention.

In one exemplary embodiment, a water softener is provided including a water tank for holding resin beads, the water tank comprising a water inlet for receiving untreated water and a water outlet for discharging treated water, a salt reservoir for generating brine that is used to regenerate the resin beads, a conductivity sensing assembly operably coupled to the water tank, and a controller in operative communication with the conductivity sensing assembly. The controller is configured to obtain an untreated electrical conductivity of the untreated water, obtain a treated electrical conductivity of the treated water, determine that a regeneration cycle is needed based at least in part on the untreated electrical conductivity and the treated electrical conductivity, and perform the regeneration cycle in response to determining that the regeneration cycle is needed.

In another exemplary embodiment, a method of operating a water softener is provided. The water softener includes a water tank for holding resin beads, the water tank comprising a water inlet for receiving untreated water and a water outlet for discharging treated water, a salt reservoir for generating brine that is used to regenerate the resin beads, and a conductivity sensing assembly operably coupled to the water tank. The method includes obtaining an untreated electrical conductivity of the untreated water, obtaining a treated electrical conductivity of the treated water, determining that a regeneration cycle is needed based at least in part on the untreated electrical conductivity and the treated electrical conductivity, and performing the regeneration cycle in response to determining that the regeneration cycle is needed.

These and other features, aspects and advantages of the present invention will become better understood with reference to the following description and appended claims. The accompanying drawings, which are incorporated in and constitute a part of this specification, illustrate embodiments of the invention and, together with the description, serve to explain the principles of the invention.

### BRIEF DESCRIPTION OF THE DRAWINGS

A full and enabling disclosure of the present invention, including the best mode thereof, directed to one of ordinary skill in the art, is set forth in the specification, which makes reference to the appended figures.

FIG. 1 provides a perspective view of a water softener according to an example embodiment of the present subject matter.

FIG. 2 provides a side view of the example water softener of FIG. 1 according to an example embodiment of the present subject matter.

FIG. 3 provides a top view of the example water softener of FIG. 1 according to an example embodiment of the present subject matter.

FIG. 4 provides a front view of the example water softener of FIG. 1 with a lid in an open position according to an example embodiment of the present subject matter.

FIG. 5 provides a top view of the example water softener of FIG. 1 with a lid in an open position according to an example embodiment of the present subject matter.

FIG. 6 provides a top view of the example water softener of FIG. 1 with a lid in an open position according to an example embodiment of the present subject matter.

FIG. 7 provides a method of performing a regeneration cycle of a water softener according to an example embodiment of the present subject matter.

FIG. 8 is a plot of an inlet and outlet electrical conductivity over time during operation of a water softener according to an example embodiment of the present subject matter.

FIG. 9 is a plot of a rate of change of an electrical conductivity difference over time during operation of a water softener according to an example embodiment of the present subject matter.

FIG. 10 is a plot of an electrical conductivity difference and the rate of change of the electrical conductivity difference over time during operation of a water softener according to an example embodiment of the present subject matter.

Repeat use of reference characters in the present specification and drawings is intended to represent the same or analogous features or elements of the present invention.

### DETAILED DESCRIPTION OF THE INVENTION

Reference now will be made in detail to embodiments of the invention, one or more examples of which are illustrated in the drawings. Each example is provided by way of explanation of the invention, not limitation of the invention. In fact, it will be apparent to those skilled in the art that various modifications and variations can be made in the present invention without departing from the scope or spirit of the invention. For instance, features illustrated or described as part of one embodiment can be used with another embodiment to yield a still further embodiment. Thus, it is intended that the present invention covers such modifications and variations as come within the scope of the appended claims and their equivalents.

As used herein, the terms “first,” “second,” and “third” may be used interchangeably to distinguish one component from another and are not intended to signify location or importance of the individual components. The terms “includes” and “including” are intended to be inclusive in a manner similar to the term “comprising.” Similarly, the term “or” is generally intended to be inclusive (i.e., “A or B” is intended to mean “A or B or both”). The term “at least one of” in the context of, e.g., “at least one of A, B, and C” refers to only A, only B, only C, or any combination of A, B, and C. In addition, here and throughout the specification and claims, range limitations may be combined and/or interchanged. Such ranges are identified and include all the sub-ranges contained therein unless context or language indicates otherwise. For example, all ranges disclosed herein are inclusive of the endpoints, and the endpoints are independently combinable with each other. The singular forms “a,” “an,” and “the” include plural references unless the context clearly dictates otherwise.

Approximating language, as used herein throughout the specification and claims, may be applied to modify any quantitative representation that could permissibly vary without resulting in a change in the basic function to which it is related. Accordingly, a value modified by a term or terms, such as “generally,” “about,” “approximately,” and “substantially,” are not to be limited to the precise value specified. In at least some instances, the approximating language may correspond to the precision of an instrument for measuring the value, or the precision of the methods or machines for constructing or manufacturing the components and/or systems. For example, the approximating language may refer to being within a 10 percent margin, i.e., including values within ten percent greater or less than the stated value. In this regard, for example, when used in the context of an angle or direction, such terms include within ten degrees greater or less than the stated angle or direction, e.g., “generally vertical” includes forming an angle of up to ten degrees in any direction, e.g., clockwise or counterclockwise, with the vertical direction V. The terms “upstream” and “downstream” refer to the relative flow direction with respect to fluid flow in a fluid pathway. For example, “upstream” refers to the flow direction from which the fluid flows, and “downstream” refers to the flow direction to which the fluid flows.

The word “exemplary” is used herein to mean “serving as an example, instance, or illustration.” In addition, references to “an embodiment” or “one embodiment” does not necessarily refer to the same embodiment, although it may. Any implementation described herein as “exemplary” or “an embodiment” is not necessarily to be construed as preferred or advantageous over other implementations. Moreover, each example is provided by way of explanation of the invention, not limitation of the invention. In fact, it will be apparent to those skilled in the art that various modifications and variations can be made in the present invention without departing from the scope of the invention. For instance, features illustrated or described as part of one embodiment can be used with another embodiment to yield a still further embodiment. Thus, it is intended that the present invention covers such modifications and variations as come within the scope of the appended claims and their equivalents.

Referring now to the figures, an exemplary appliance will be described in accordance with exemplary aspects of the present subject matter. As illustrated, water softener 100 generally defines a vertical direction V, a lateral direction L, and a transverse direction T, each of which is mutually perpendicular, such that an orthogonal coordinate system is generally defined.

According to exemplary embodiments, water softener 100 includes a cabinet 102 that is generally configured for containing and/or supporting various components of water softener 100 and which may also define one or more internal chambers or compartments of water softener 100. In this regard, as used herein, the terms “cabinet,” “housing,” and the like are generally intended to refer to an outer frame or support structure for water softener 100, e.g., including any suitable number, type, and configuration of support structures formed from any suitable materials, such as a system of elongated support members, a plurality of interconnected panels, or some combination thereof. It should be appreciated that cabinet 102 does not necessarily require an enclosure and may simply include open structure supporting various elements of water softener 100. By contrast, cabinet 102 may enclose some or all portions of an interior of cabinet 102. It should be appreciated that cabinet 102 may have any suitable size, shape, and configuration while remaining within the scope of the present subject matter.

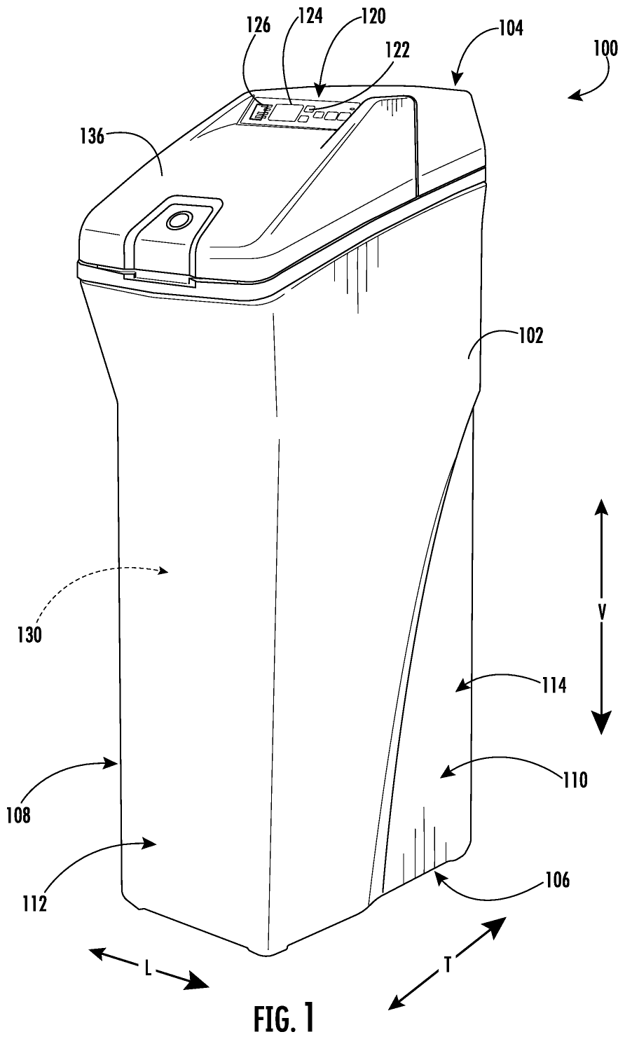

As illustrated, cabinet 102 generally extends between a top 104 and a bottom 106 along the vertical direction V, between a first side 108 (e.g., the left side when viewed from the front as in FIG. 1) and a second side 110 (e.g., the right side when viewed from the front as in FIG. 1) along the lateral direction L, and between a front 112 and a rear 114 along the transverse direction T. In general, terms such as “left,” “right,” “front,” “rear,” “top,” or “bottom” are used with reference to the perspective of a user accessing water softener 100.

Referring again to FIG. 1, water softener 100 may include a control panel 120 that may represent a general-purpose Input/Output (“GPIO”) device or functional block for water softener 100. In some embodiments, control panel 120 may include or be in operative communication with one or more user input devices 122, such as one or more of a variety of digital, analog, electrical, mechanical, or electro-mechanical input devices including rotary dials, control knobs, push buttons, toggle switches, selector switches, and touch pads. Additionally, water softener 100 may include a display 124, such as a digital or analog display device generally configured to provide visual feedback regarding the operation of water softener 100. For example, display 124 may be provided on control panel 120 and may include one or more status lights, screens, or visible indicators. According to exemplary embodiments, user input devices 122 and display 124 may be integrated into a single device, e.g., including one or more of a touchscreen interface, a capacitive touch panel, a liquid crystal display (LCD), a plasma display panel (PDP), a cathode ray tube (CRT) display, or other informational or interactive displays.

Water softener 100 may further include or be in operative communication with a processing device or a controller 126 that may be generally configured to facilitate appliance operation. In this regard, control panel 120, user input devices 122, and display 124 may be in communication with controller 126 such that controller 126 may receive control inputs from user input devices 122, may display information using display 124, and may otherwise regulate operation of water softener 100. For example, signals generated by controller 126 may operate water softener 100, including any or all system components, subsystems, or interconnected devices, in response to the position of user input devices 122 and other control commands. Control panel 120 and other components of water softener 100 may be in communication with controller 126 via, for example, one or more signal lines or shared communication busses. In this manner, Input/Output (“I/O”) signals may be routed between controller 126 and various operational components of water softener 100.

As used herein, the terms “processing device,” “computing device,” “controller,” or the like may generally refer to any suitable processing device, such as a general or special purpose microprocessor, a microcontroller, an integrated circuit, an application specific integrated circuit (ASIC), a digital signal processor (DSP), a field-programmable gate array (FPGA), a logic device, one or more central processing units (CPUs), a graphics processing units (GPUs), processing units performing other specialized calculations, semiconductor devices, etc. In addition, these “controllers” are not necessarily restricted to a single element but may include any suitable number, type, and configuration of processing devices integrated in any suitable manner to facilitate appliance operation. Alternatively, controller 126 may be constructed without using a microprocessor, e.g., using a combination of discrete analog and/or digital logic circuitry (such as switches, amplifiers, integrators, comparators, flip-flops, AND/OR gates, and the like) to perform control functionality instead of relying upon software.

Controller 126 may include, or be associated with, one or more memory elements or non-transitory computer-readable storage mediums, such as RAM, ROM, EEPROM, EPROM, flash memory devices, magnetic disks, or other suitable memory devices (including combinations thereof). These memory devices may be a separate component from the processor or may be included onboard within the processor. In addition, these memory devices can store information and/or data accessible by the one or more processors, including instructions that can be executed by the one or more processors. It should be appreciated that the instructions can be software written in any suitable programming language or can be implemented in hardware. Additionally, or alternatively, the instructions can be executed logically and/or virtually using separate threads on one or more processors.

For example, controller 126 may be operable to execute programming instructions or micro-control code associated with an operating cycle of water softener 100. In this regard, the instructions may be software or any set of instructions that when executed by the processing device, cause the processing device to perform operations, such as running one or more software applications, displaying a user interface, receiving user input, processing user input, etc. Moreover, it should be noted that controller 126 as disclosed herein is capable of and may be operable to perform any methods, method steps, or portions of methods as disclosed herein. For example, in some embodiments, methods disclosed herein may be embodied in programming instructions stored in the memory and executed by controller 126.

The memory devices may also store data that can be retrieved, manipulated, created, or stored by the one or more processors or portions of controller 126. The data can include, for instance, data to facilitate performance of methods described herein. The data can be stored locally (e.g., on controller 126) in one or more databases and/or may be split up so that the data is stored in multiple locations. In addition, or alternatively, the one or more database(s) can be connected to controller 126 through any suitable network(s), such as through a high bandwidth local area network (LAN) or wide area network (WAN). In this regard, for example, controller 126 may further include a communication module or interface that may be used to communicate with one or more other component(s) of water softener 100, controller 126, an external appliance controller, or any other suitable device, e.g., via any suitable communication lines or network(s) and using any suitable communication protocol. The communication interface can include any suitable components for interfacing with one or more network(s), including for example, transmitters, receivers, ports, controllers, antennas, or other suitable components.

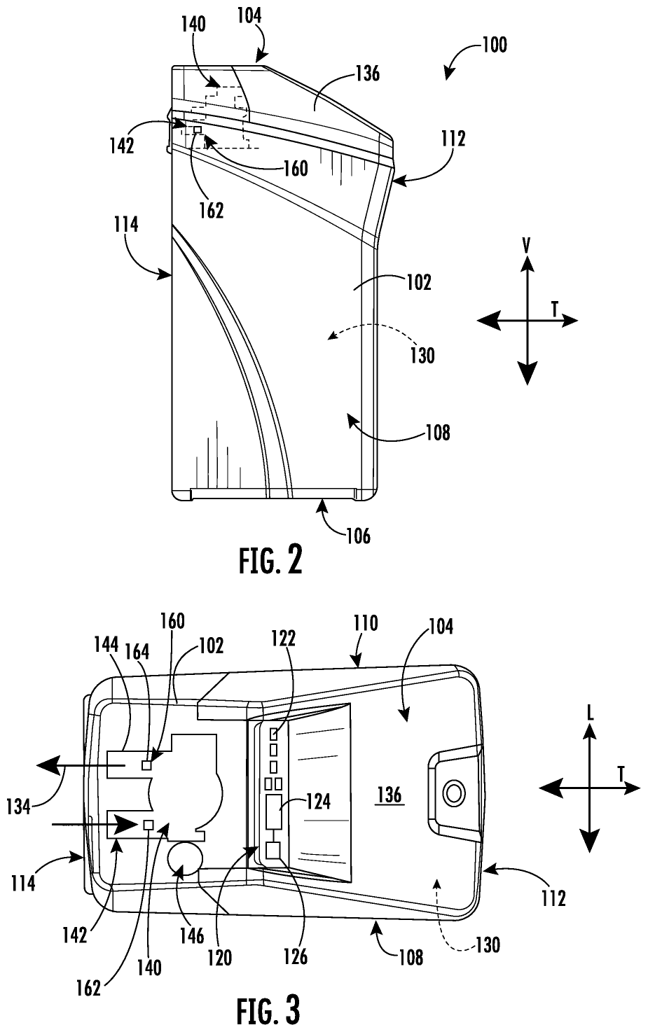

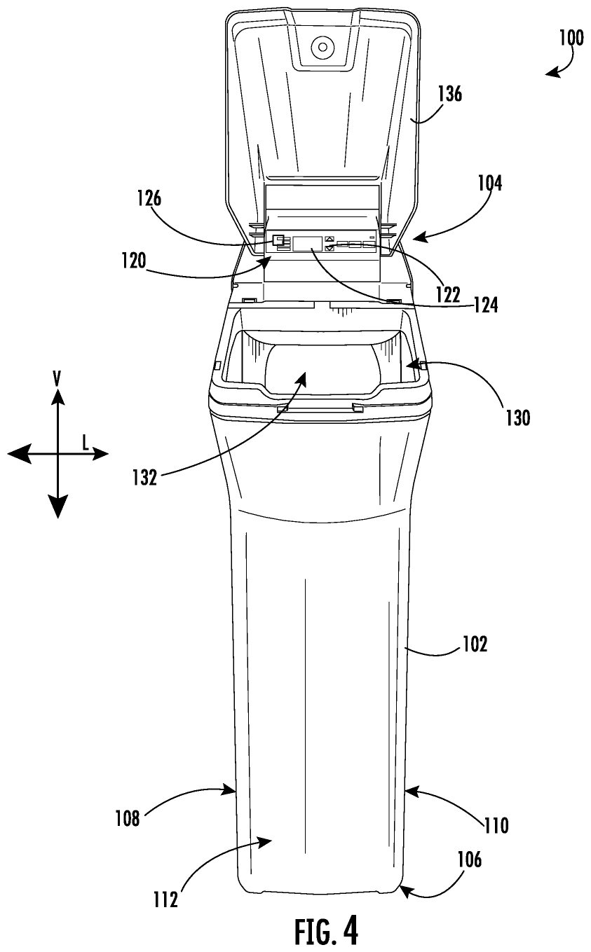

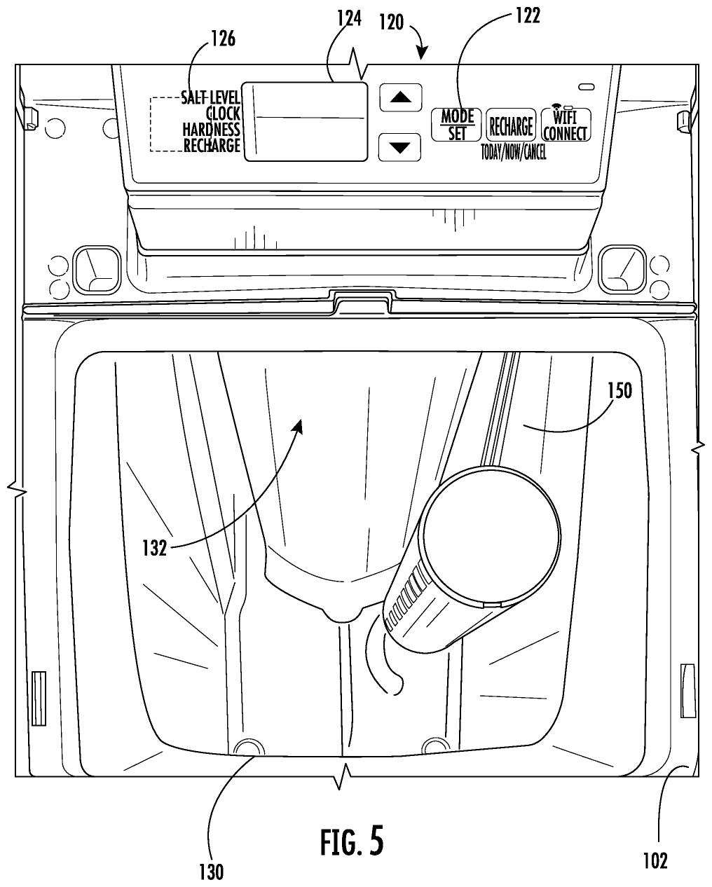

Referring now generally to FIGS. 1 through 6, cabinet 102 of water softener 100 may generally define a salt reservoir 130 that is generally configured for generating brine for regeneration cycles. In addition, a water tank 132 may be positioned within cabinet 102 and may be fluid separated from salt reservoir 130. According to alternative embodiments, water tank 132 may be separate from cabinet 102. Within water tank 132, a plurality of resin beads (not shown) may be positioned for softening a flow of water (e.g., identified schematically by reference numeral 134). As explained briefly above, during a softening cycle, the flow of water 134 passes through water tank 132 where the resin beads, which are saturated with sodium, exchange calcium and magnesium ions in the water with sodium ions. The process of removing these minerals softens the water which is then discharged from water softener 100. Water softener 100 may further include a lid 136 that is pivotally mounted to a top of cabinet 102, e.g., to provide selective access to salt reservoir 130.

As illustrated, water softener 100 further includes a valve assembly 140 that selectively directs the flow of water 134 through water tank 132, e.g., from an inlet 142 to an outlet 144. In addition, valve assembly 140 may be fluidly coupled to an external drain 146, e.g., for periodically discharging brine solution, rinsing water, etc. from water softener 100. It should be appreciated that valve assembly 140 may include numerous valves, manifolds, and other flow regulating features to selectively direct fresh water, brine solution, and other flows of fluid throughout water softener 100. Further details regarding valve assembly 140 are omitted here for brevity.

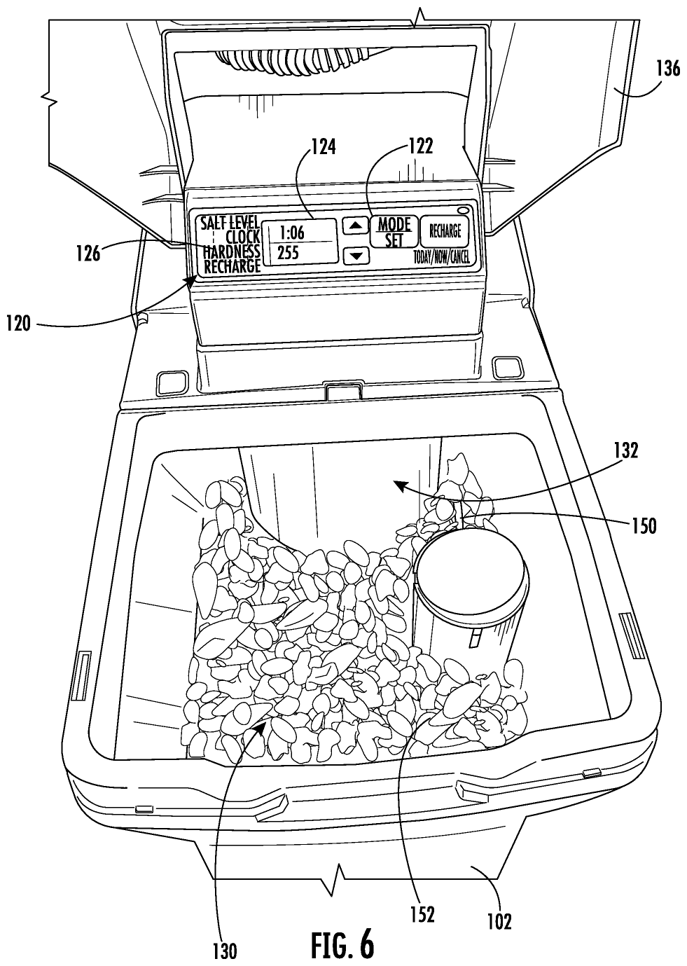

Notably, over time, the resin beads within water tank 132 become saturated with the minerals that have been extracted from the hard water, and water softener 100 must go through a cleaning process. The cleaning process is often referred to as “recharge” or “regeneration.” Accordingly, a brine tank conduit 150 may provide fluid communication between valve assembly 140 and salt reservoir 130. As illustrated in FIG. 6, salt pellets 152 may be added to salt reservoir 130 and water may be periodically added to salt reservoir 130 through valve assembly 140, e.g., to form a bring solution that is used in the regeneration process. More specifically, after brine is created in salt reservoir, this brine may be selectively urged through brine tank conduit 150 into water tank 132 and through the resin beads to regenerate those the resin beads to facilitate further water softening.

The regeneration process may generally include five stages: Fill, Brining, Brine Rinse, Backwash, and Fast Rinse. Although an exemplary description of a regeneration process and the performance of each of these stages are described below, it should be appreciated that the stages or manner in which they are performed may vary while remaining within the scope of the present subject matter.

The Fill portion of the regeneration cycle may include the use of brine (e.g., salt dissolved in water) to clean the hard minerals from the resin beads. To make the brine, water may be supplied into salt reservoir 130 during the fill stage. The time this takes can vary from a few minutes to maybe 20 minutes. During the Brining portion of the regeneration cycle, brine may travel from the salt reservoir 130 up into the water tank 132 and may act as a cleaning agent to remove hard minerals from the resin beads. The hard minerals and brine may then be discharged into external drain 146. The time this takes can vary from 30 minutes to maybe 100 minutes.

The Brine Rinse portion of the regeneration cycle may include operating valve assembly 140 to stop the flow of brine while continuing to flow water along the same path, e.g., to flush hard minerals and brine from the water tank 132 into external drain 146. During the Backwash portion of the regeneration cycle, water may flow up through the water tank 132 at a fast flow rate, e.g., to flush out any accumulated iron, dirt, and sediment from the resin bed and pass it into external drain 146. The time this takes can vary but is generally 3 to 10 minutes. In the Fast Rinse portion of the regeneration cycle, a fast flow of water is passed down through the water tank 132. The fast flow flushes brine from the bottom of water tank 132 and serves to pack in the resin beads. Water softener 100 may return to water softening service after the Fast Rinse. The time this takes can vary but is generally 3 to 10 minutes.

As explained herein, monitoring the conductivity of the water within water softener 100 may provide useful insight as to when a regeneration cycle should be performed. More specifically, using conductivity measurements as described herein may facilitate initiation of a regeneration cycle before the water softening performance is degraded but not too soon such that water consumption, salt consumption, and system efficiency and operability are negatively impacted. Although an exemplary system for monitoring conductivity is described below and illustrated in the figures, it should be appreciated that variations and modifications may be made while remaining within the scope of the present subject matter.

As illustrated, water softener 100 includes a conductivity sensing assembly 160 operably coupled to water tank 132 for measuring the conductivity of the water at locations within water softener 100 to provide useful information on the remaining life of the resin beads within water tank 132. As used herein, conductivity sensors may refer to any suitable device or system of devices suitable for measuring the electrical conductivity of water. Although the use of two sensors is described herein, additional sensors may be used according to alternative embodiments.

For example, conductivity sensing assembly 160 includes a first conductivity sensor 162 positioned upstream of the resin beads for obtaining an untreated electrical conductivity (i.e., an electrical conductivity of the water 134 prior to treatment or softening). According to the example embodiment, first conductivity sensor 162 is positioned at inlet 142 of water tank 132, though any position upstream of resin beads may be used. In addition, conductivity sensing assembly 160 includes a second conductivity sensor 164 positioned downstream of the resin beads for obtaining a treated electrical conductivity (i.e., an electrical conductivity of the water 134 after to treatment or softening). According to the example embodiment, second conductivity sensor 164 is positioned at outlet 144 of water tank 132, though any position downstream of resin beads may be used.

Now that the construction of water softener 100 according to exemplary embodiments have been presented, an exemplary method 200 of operating a water softener and performing a regeneration cycle will be described. In this regard, method 200 provides an example method for recharging resin beads in a water softener. Although the discussion below refers to the exemplary method 200 of operating water softener 100, one skilled in the art will appreciate that the exemplary method 200 is applicable to the operation of a variety of other water softening appliances having different configurations, constructions, water softening technologies, etc. In exemplary embodiments, the various method steps as disclosed herein may be performed by controller 126 or another dedicated controller or processor.

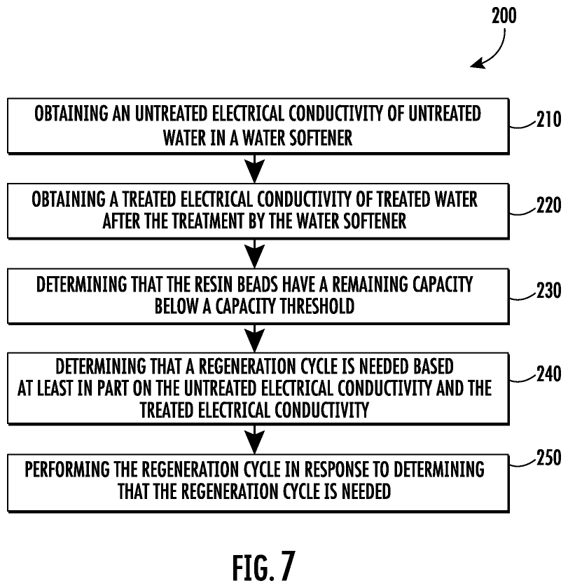

Referring now to FIG. 7, method 200 includes, at step 210, obtaining an untreated electrical conductivity of untreated water in a water softener. In this regard, continuing the example from above, first conductivity sensor 162 may be used to obtain the electrical conductivity of the flow of water 134 passing through inlet 142. This untreated electrical conductivity is the conductivity of the tap water from the water supply source, e.g., the “hard” water that is being treated by water softener 100. This conductivity may be obtained periodically, continuously, or at any other suitable interval or frequency.

Step 220 includes obtaining a treated electrical conductivity of treated water after treatment by the water softener. In this regard, continuing the example from above, second conductivity sensor 164 may be used to obtain the electrical conductivity of the flow of water 134 passing through outlet 144. This treated electrical conductivity is the conductivity of the treated water after it has passed through the resin beads with water tank 132, e.g., the “softened” water that is passed to the water distribution system and fixtures within the house or residence where water softener 100 is installed. Similar to the untreated measurement, this conductivity may be obtained periodically, continuously, or at any other suitable interval or frequency.

Step 230 may include determining that the resin beads have a remaining capacity below a capacity threshold. In this regard, for example, the remaining softening capacity of the resin beads may be estimated based on the volume of water that has been passed through water softener 100 since the last recharge cycle. Alternatively, the remaining softening capacity may be based on the amount of time that has passed since the last regeneration cycle or may be determined in any other manner. For example, the remaining capacity may be quantified as a percentage, e.g., 30% capacity, 20% capacity, or 10% capacity remaining. Similarly, the capacity threshold may be set by a manufacturer or consumer, and may be quantified as a percentage, e.g., 30% capacity, 20% capacity, or 10% capacity remaining. It may desirable to perform step 230 to prevent the performance of unnecessary regeneration cycles due to minor nuisance fluctuations in water conductivity, e.g., due to variations in inlet water hardness, etc. In other words, it may be desirable to omit the performance of steps 240 and 250 (described below), if the resin beads clearly have plenty of remaining treatment capacity.

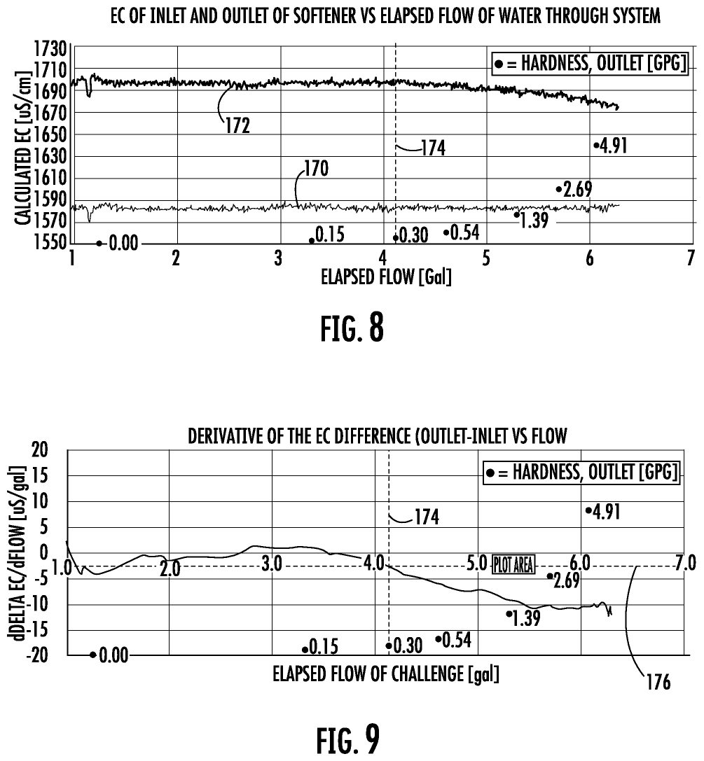

Step 240 may include determining that a regeneration cycle is needed based at least in part on the untreated electrical conductivity and the treated electrical conductivity. In this regard, by monitoring the untreated versus treated electrical conductivity, controller 126 of water softener 100 may make informed decisions about when a regeneration cycle should be performed. For example, FIGS. 8 through 10 illustrate the relationships between electrical conductivity and water hardness over the softening capacity of an example bed of resin beads. Specifically, FIG. 8 illustrates an inlet conductivity (e.g., identified by reference numeral 170), an outlet conductivity (e.g., identified by reference numeral 172), and an example trigger threshold (e.g., identified by reference numeral 174). As illustrated, the inlet conductivity 170 may remain relatively constant, while the outlet conductivity 172 slowly decreases toward the end of life of the resin beads. Trigger threshold 174 is an example threshold at which the regeneration cycle should be performed to ensure desired performance of water softener 100 (without performing unnecessary regeneration cycles). As shown, if the regeneration cycles is not performed, the water hardness may increase very quickly at the end of life of the resin beads.

According to an example embodiment, determining that the regeneration cycle is needed based at least in part on the untreated electrical conductivity and the treated electrical conductivity may include determining that a conductivity difference between the untreated electrical conductivity and the treated electrical conductivity falls below a predetermined difference threshold. In this regard, as the difference between the untreated and treated electrical conductivity decreases, this may indicate that the resin beads are no longer effective and that a regeneration process should be performed. The use of an electrical conductivity difference may be particularly useful if the inlet hardness is known or constant.

According to still other embodiments, determining that the regeneration cycle is needed based at least in part on the untreated electrical conductivity and the treated electrical conductivity may include determining a rate of change of the conductivity difference and determining that the rate of change falls below a predetermined rate of change threshold. In this regard, because the inlet hardness (and thus electrical conductivity) may vary based on a variety of factors, it may be more desirable to identify the rate of change of the conductivity difference. This rate of change may be based on the amount of time passed (e.g., a time-based derivative), based on the volume of water treated (e.g., a volume-based derivative), or in any other suitable manner.

For example, as shown in FIG. 9, as the resin beads reach their end of life the rate of change of electrical conductivity may begin to drop below zero. Simultaneously, the effectiveness of the water softening process may be degraded and the water hardness at the outlet may begin to increase. Accordingly, by monitoring this rate of change of the electrical conductivity, the trigger threshold 174 where a regeneration process should be performed may be determined. For example, the predetermined rate of change threshold (e.g., identified by reference numeral 176) may be used to identify the trigger threshold 174, i.e., when the rate of change drops below the predetermined rate of change threshold 176, a regeneration cycle may be performed.

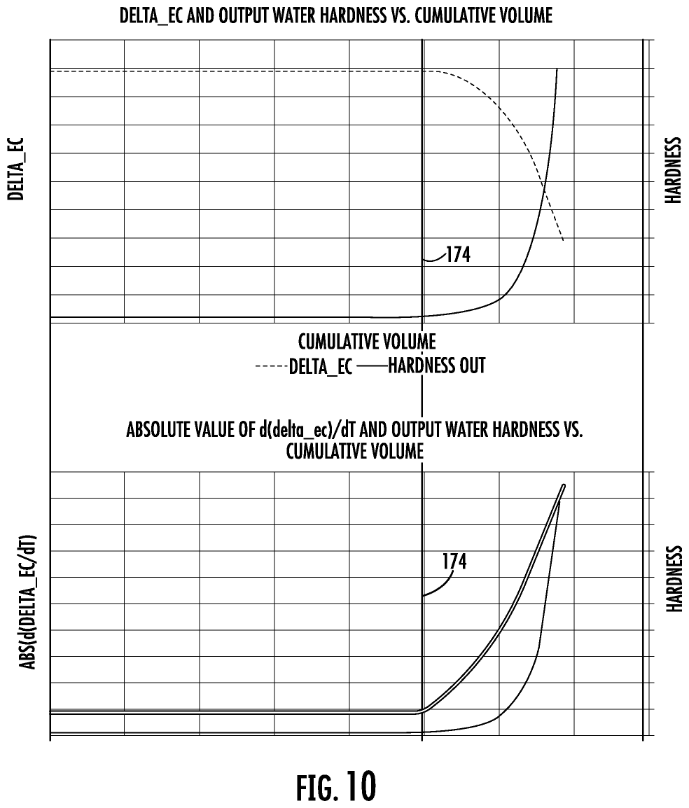

By contrast, referring now to FIG. 10, the absolute value of the rate of change of the electrical conductivity may also be used. For example, determining that the regeneration cycle is needed based at least in part on the untreated electrical conductivity and the treated electrical conductivity may include determining a rate of change of the conductivity difference and determining that an absolute value of the rate of change exceeds an absolute value threshold. In this regard, as soon as the rate of change of the electrical conductivity exceeds an absolute value threshold, a regeneration cycle may be performed.

According to example embodiments, method 200 may further include means for compensating in the event that the water hardness at the inlet changes significantly, e.g., due to a water supply disruption, etc. For example, monitoring the rate of change in electrical conductivity may result in the performance of undesirable regeneration cycles if the input hardness changes rapidly and significantly. Accordingly, method 200 may include identifying a variation in the electrical conductivity of the untreated water, wherein the regeneration cycle is not performed in response to identifying the variation in the electrical conductivity of the untreated water.

Step 250 may include performing the regeneration cycle in response to determining that the regeneration cycle is needed (e.g., at step 240). For example, performing the regeneration cycle may include controller 126 manipulating valve assembly 140 to perform the steps described above, e.g., such as urging a flow of the brine into the water tank and over the resin beads, draining the flow of brine that was used to regenerate the resin beads, rinsing the resin beads, refilling the salt tank, etc. Other regeneration steps are possible and within the scope of the present subject matter.

FIG. 7 depicts steps performed in a particular order for purposes of illustration and discussion. Those of ordinary skill in the art, using the disclosures provided herein, will understand that the steps of any of the methods discussed herein can be adapted, rearranged, expanded, omitted, or modified in various ways without deviating from the scope of the present disclosure. Moreover, although aspects of method 200 are explained using water softener 100 as an example, it should be appreciated that these methods may be applied to the operation of any suitable water softening appliance.

As explained herein, aspects of the present subject matter are generally directed to a regeneration sensor or method for determining when a regeneration cycle should be performed in an ion exchange water softener. A method of detecting when the ion exchange water softener's resin needs to be regenerated may include monitoring the electrical conductivity of inlet and outlet water of the water softener. The method may observe an absence of an increase in electrical conductivity, which is associated with proper functioning ion exchange.

According to example embodiments, an ion exchanging resin modifies the ionic composition of treated water (e.g., each ion Ca2+ is replaced by two ions of Na+). This change in the ionic composition results in a conductivity difference (Δ_{EC}) between the electrical conductivity of water before (ECᵢₙ), and after (ECₒᵤₜ) the resin acts on the water (e.g., Δ_{EC}=ECᵢₙ−ECₒᵤₜ). Two conductivity cells may be used in the water softener, e.g., the first cell being placed upstream of the resin and the second cell being placed downstream of the resin. The cells monitor the conductivity difference (Δ_{EC}), and the rate of change of the conductivity difference (d(Δ_{EC})/dT=Δ_{EC}/time_interval) may be calculated. During the softening cycle, the conductivity difference (Δ_{EC}) remains relatively constant and d(Δ_{EC})/dT is close to zero. At a breakthrough point of the resin, ECₒᵤₜ begins changing, which changes the conductivity difference (Δ_{EC}) and results in increase of the absolute value of d(Δ_{EC})/dT. When the system detects that the absolute value of d(Δ_{EC})/dT is above a certain threshold, a regeneration cycle may be initiated.

This written description uses examples to disclose the invention, including the best mode, and also to enable any person skilled in the art to practice the invention, including making and using any devices or systems and performing any incorporated methods. The patentable scope of the invention is defined by the claims, and may include other examples that occur to those skilled in the art. Such other examples are intended to be within the scope of the claims if they include structural elements that do not differ from the literal language of the claims, or if they include equivalent structural elements with insubstantial differences from the literal languages of the claims.

What is claimed is:

1. A water softener comprising:
a water tank for holding resin beads, the water tank comprising a water inlet for receiving untreated water and a water outlet for discharging treated water;
a salt reservoir for generating brine that is used to regenerate the resin beads;
a conductivity sensing assembly operably coupled to the water tank; and
a controller in operative communication with the conductivity sensing assembly, the controller being configured to:
obtain an untreated electrical conductivity of the untreated water;
obtain a treated electrical conductivity of the treated water;
determine that a regeneration cycle is needed based at least in part on the untreated electrical conductivity and the treated electrical conductivity; and
perform the regeneration cycle in response to determining that the regeneration cycle is needed.

2. The water softener of claim 1, wherein determining that the regeneration cycle is needed based at least in part on the untreated electrical conductivity and the treated electrical conductivity comprises:
determining that a conductivity difference between the untreated electrical conductivity and the treated electrical conductivity falls below a predetermined difference threshold.

3. The water softener of claim 2, wherein determining that the regeneration cycle is needed based at least in part on the untreated electrical conductivity and the treated electrical conductivity comprises:
determining a rate of change of the conductivity difference; and
determining that the rate of change falls below a predetermined rate of change threshold.

4. The water softener of claim 2, wherein determining that the regeneration cycle is needed based at least in part on the untreated electrical conductivity and the treated electrical conductivity comprises:
determining a rate of change of the conductivity difference; and
determining that an absolute value of the rate of change exceeds an absolute value threshold.

5. The water softener of claim 1, wherein the conductivity sensing assembly comprises:
a first conductivity sensor positioned upstream of the resin beads for obtaining the untreated electrical conductivity; and
a second conductivity sensor positioned downstream of the resin beads for obtaining the treated electrical conductivity.

6. The water softener of claim 5, wherein the first conductivity sensor is mounted to a water inlet of the water softener and the second conductivity sensor is mounted to a water outlet of the water softener.

7. The water softener of claim 1, further comprising:
a brine tank conduit providing fluid communication between the water tank and the salt reservoir; and
an external drain for receiving a flow of discharge water.

8. The water softener of claim 7, further comprising:
a valve assembly for selectively regulating a flow of water through the water inlet, the water outlet, the brine tank conduit, or the external drain.

9. The water softener of claim 1, wherein the controller is further configured to:
determine that the resin beads have a remaining capacity below a capacity threshold; and
determine that the regeneration cycle is needed after determining that the resin beads have the remaining capacity below the capacity threshold.

10. The water softener of claim 1, wherein the controller is further configured to:
identify a variation in the electrical conductivity of the untreated water, wherein the regeneration cycle is not performed in response to identifying the variation in the electrical conductivity of the untreated water.

11. The water softener of claim 1, wherein performing the regeneration cycle comprises:
urging a flow of the brine into the water tank and over the resin beads.

12. The water softener of claim 11, wherein performing the regeneration cycle further comprises:
draining the flow of brine that was used to regenerate the resin beads.

13. A method of operating a water softener, the water softener comprising a water tank for holding resin beads, the water tank comprising a water inlet for receiving untreated water and a water outlet for discharging treated water, a salt reservoir for generating brine that is used to regenerate the resin beads, and a conductivity sensing assembly operably coupled to the water tank, the method comprising:
obtaining an untreated electrical conductivity of the untreated water;
obtaining a treated electrical conductivity of the treated water;
determining that a regeneration cycle is needed based at least in part on the untreated electrical conductivity and the treated electrical conductivity; and
performing the regeneration cycle in response to determining that the regeneration cycle is needed.

14. The method of claim 13, wherein determining that the regeneration cycle is needed based at least in part on the untreated electrical conductivity and the treated electrical conductivity comprises:
determining that a conductivity difference between the untreated electrical conductivity and the treated electrical conductivity falls below a predetermined difference threshold.

15. The method of claim 14, wherein determining that the regeneration cycle is needed based at least in part on the untreated electrical conductivity and the treated electrical conductivity comprises:
determining a rate of change of the conductivity difference; and
determining that the rate of change exceeds a predetermined rate of change threshold.

16. The method of claim 13, wherein the conductivity sensing assembly comprises:
a first conductivity sensor positioned upstream of the resin beads for obtaining the untreated electrical conductivity; and
a second conductivity sensor positioned downstream of the resin beads for obtaining the treated electrical conductivity.

17. The method of claim 13, wherein the water softener further comprises:
a brine tank conduit providing fluid communication between the water tank and the salt reservoir;
an external drain for receiving a flow of discharge water; and
a valve assembly for selectively regulating a flow of water through the water inlet, the water outlet, the brine tank conduit, or the external drain.

18. The method of claim 13, further comprising:
determining that the resin beads have a remaining capacity below a capacity threshold; and
determining that the regeneration cycle is needed after determining that the resin beads have the remaining capacity below the capacity threshold.

19. The method of claim 13, further comprising:
identifying a variation in the electrical conductivity of the untreated water, wherein the regeneration cycle is not performed in response to identifying the variation in the electrical conductivity of the untreated water.

20. The method of claim 13, wherein performing the regeneration cycle comprises:
urging a flow of the brine into the water tank and over the resin beads; and
draining the flow of brine that was used to regenerate the resin beads.
